(19) United States
(12) Patent Application Publication
(10) Pub. No.: US 2016/0124207 A1
(43) Pub. Date: May 5, 2016

(54) MICROSCOPE SYSTEM

(71) Applicant: OLYMPUS CORPORATION, Tokyo (JP)

(72) Inventor: Shinichiro AIZAKI, Tokyo (JP)

(73) Assignee: OLYMPUS CORPORATION, Tokyo (JP)

(21) Appl. No.: 14/925,318

(22) Filed: Oct. 28, 2015

(30) Foreign Application Priority Data
Nov. 4, 2014 (JP) 2014-224646

(51) Int. Cl. G02B 21/36; G02B 7/38

(52) U.S. Cl. CPC G02B 21/365; G02B 7/38

(57) ABSTRACT

A microscope system including a microscope main unit that acquires an image of a specimen; a focus-evaluation-value calculating portion that calculates a focus evaluation value in at least one or more evaluation areas defined in a field-of-view range, while moving the focal position with the microscope main unit; and a display portion that displays the focus evaluation value calculated by the focus-evaluation-value calculating portion in chronological order.

### CROSS-REFERENCE TO RELATED APPLICATIONS

This application is based on Japanese Patent Application No. 2014-224646, the contents of which are incorporated herein by reference.

### TECHNICAL FIELD

The present invention relates to a microscope system.

### BACKGROUND ART

In autofocus devices installed in measuring apparatuses, such as optical microscopes, there are known methods in which the contrast of an image of a specimen is calculated, and the obtained contrast is used as an evaluation value based on which autofocus is performed, and in which the spatial frequency of an image is analyzed, and the spectral intensity of the obtained spatial frequency is used as an evaluation value based on which autofocus is performed (for example, see PTLs 1 and 2).

### CITATION LIST

### Patent Literature

{PTL 1} Japanese Unexamined Patent Application, Publication No. 2002-162558
{PTL 2} Japanese Unexamined Patent Application, Publication No. 2006-301270

### SUMMARY OF INVENTION

An aspect of the present invention is a microscope system including a microscope main unit that acquires an image of a specimen; an evaluation-value calculating portion that calculates a focus evaluation value of an evaluation area defined in the acquired image, while moving the focal position with the microscope main unit; and a display portion that displays the focus evaluation value calculated by the evaluation-value calculating portion in chronological order.

### BRIEF DESCRIPTION OF DRAWINGS

FIG. 1 is a diagram showing the overall configuration of a microscope system according to an embodiment of the present invention.

FIG. 2 is a diagram showing evaluation areas defined on an image acquired by the microscope system in FIG. 1.

FIG. 3 is a diagram showing an example in-focus image, acquired by the microscope system in FIG. 1.

FIG. 4 is a diagram showing chronological data of focus evaluation values in the respective evaluation areas in a region R in FIG. 2.

FIG. 5A is a side view showing a state in which the focal position of excitation light on the specimen is sequentially moved.

FIG. 5B is a side view showing a state in which the focal position of the excitation light on the specimen is sequentially moved.

FIG. 5C is a side view showing a state in which the focal position of the excitation light on the specimen is sequentially moved.

FIG. 5D is a side view showing a state in which the focal position of the excitation light on the specimen is sequentially moved.

FIG. 5E is a side view showing a state in which the focal position of the excitation light on the specimen is sequentially moved.

FIG. 6 is a diagram showing dust adhered to a cover glass.

FIG. 7 is a diagram showing a fluorescence image acquired at the focal position in FIG. 5B.

FIG. 8 is a diagram showing a fluorescence image acquired at the focal position in FIG. 5B.

FIG. 9 is a diagram showing an example in which identification information is indicated on the chronological data in FIG. 4.

FIG. 10 is a diagram showing an example in which a state in which the focus evaluation value is at a local maximum is reported by a text indication.

FIG. 11 is a diagram showing a graph of chronological data of difference values of the focus evaluation values in FIG. 4.

FIG. 12 is a partial configuration diagram showing only a computer portion of a microscope system according to a modification of the embodiment of the present invention.

### DESCRIPTION OF EMBODIMENT

A microscope system 1 according to an embodiment of the present invention will be described below with reference to the drawings.

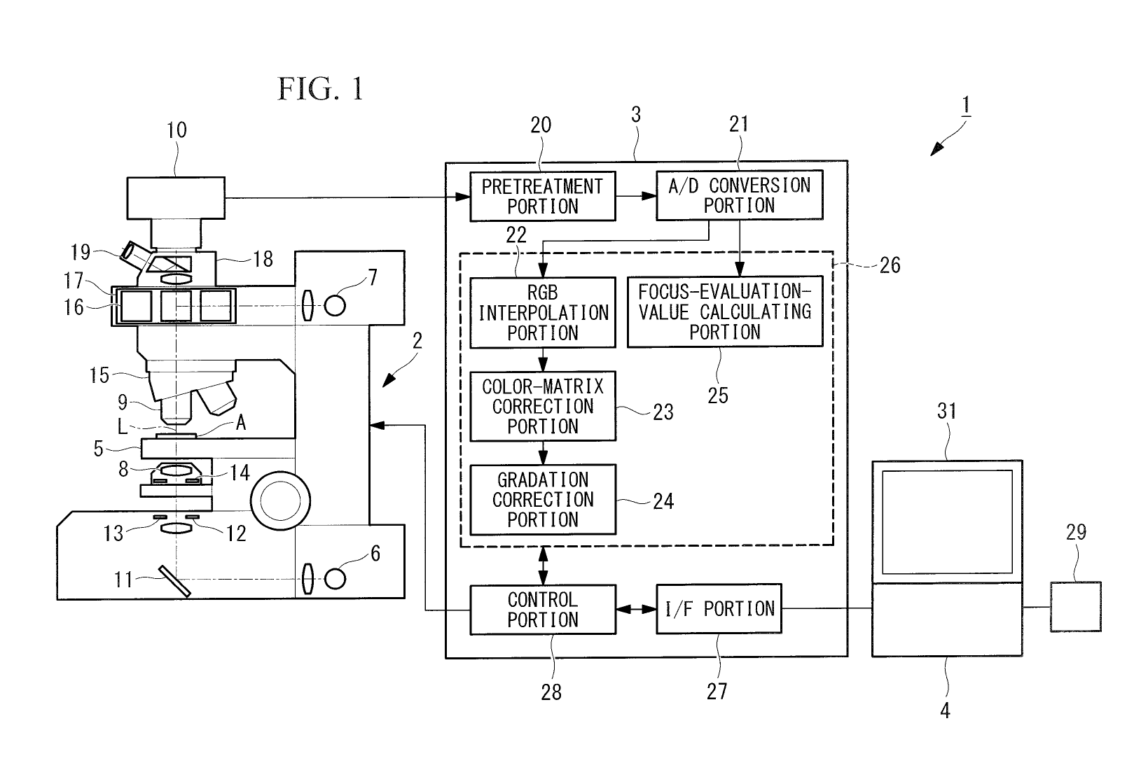

The microscope system 1 according to this embodiment is a fluorescence microscope system in which specimens A are irradiated with excitation light L to allow fluorescence observation and, as shown in FIG. 1, it includes a microscope main unit 2, a processing unit 3 connected to the microscope main unit 2, and a computer 4 connected to the processing unit 3.

The microscope main unit 2 includes a stage 5 on which the specimens A are mounted, a transillumination light source 6 and an epi-illumination light source 7 that emit illumination light, a condenser lens 8 that irradiates the specimens A with the illumination light from the transillumination light source 6, an objective lens 9 that irradiates the specimens A with the illumination light from the epi-illumination light source 7 and collects fluorescence from the specimens A, and a camera (image capturing portion) 10 that captures an image of the fluorescence collected by the objective lens 9.

In the figure, reference sign 11 denotes a mirror, reference sign 12 denotes a lens, reference sign 13 denotes a field stop, reference sign 14 denotes an aperture stop, reference sign 15 denotes an objective revolver, reference sign 16 denotes fluorescence cubes, reference sign 17 denotes a turret in which the fluorescence cubes 16 are mounted, reference sign 18 denotes a trinocular lens barrel, and reference sign 19 denotes an eyepiece. The trinocular lens barrel 18 can switch among an optical path in which the optical path is output 100% to the eyepiece 19, an optical path in which the optical path is split 50% between the eyepiece 19 and the camera 10, and an optical path in which the optical path is output 100% to the camera 10.

The processing unit 3 includes a pretreatment portion 20 that converts a signal output from an image capturing device (for example, CCD) in the camera 10 into an image signal; an A/D conversion portion 21 that converts the image signal output from the pretreatment portion 20 into a digital signal; an image processing portion 26 that functions as an RGB interpolation portion 22, a color-matrix correction portion 23, and a gradation correction portion 24 that perform image processing, such as RGB interpolation, color-matrix correction, and gradation conversion, on the image signal output from the A/D conversion portion 21 and also functions as a focus-evaluation-value calculating portion (evaluation-value calculating portion) 25 that calculates focus evaluation values; an I/F portion 27 that exchanges information with the computer 4; and a control portion 28 that controls the microscope main unit 2 and the image processing portion 26, according to instruction signals from the computer 4, which are input via the I/F portion 27.

Herein, the processing unit 3 may be either provided independently of the camera 10 or accommodated in the camera 10. When the processing unit 3 is accommodated in the camera 10, the control portion 28 functions as a camera control portion that controls only the camera 10, and a microscope control portion that controls only the microscope main unit 2, but not the camera 10, is additionally provided, separately from the camera control portion. The microscope control portion controls the microscope main unit 2, excluding the camera 10, according to instruction signals from the computer 4.

The computer 4 is, for example, a personal computer, and it includes an input portion 29 via which instructions for operating the microscope main unit 2 are input and a monitor (display portion) 31 that displays information sent from the processing unit 3.

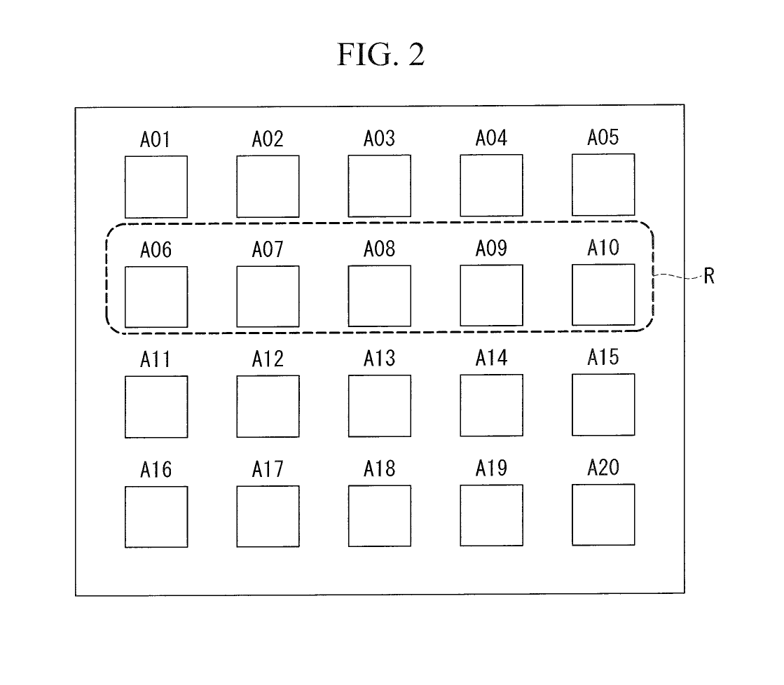

The image processing portion 26 defines a plurality of evaluation areas A01 to A20, as shown in, for example, FIG. 2, in an image acquired by the camera 10 and input through the pretreatment portion 20 and the A/D conversion portion 21, and it calculates focus evaluation values in the respective evaluation areas. Standard deviation is used as the focus evaluation value.

When a fluorescence observation instruction is input thereto from the computer 4, the control portion 28 controls the microscope main unit 2 such that the exposure time for which the image capturing device is exposed is set to a few tens of seconds (for example, 20 seconds). Then, the image processing portion 26 is controlled such that it performs image processing, such as RGB interpolation, color-matrix correction, and gradation conversion, on the image signal acquired by the image capturing device and passing through the pretreatment portion 20 and the A/D conversion portion 21.

Meanwhile, upon input of a focus adjustment instruction from the computer 4, the control portion 28 controls the microscope main unit 2 such that the exposure time for which the image capturing device is exposed is set to a fraction of a second (for example, 1/10 second) and such that several tens to several hundreds times (for example, 200 times) amplification processing is performed, as well as controls the stage 5 such that it reciprocates in a direction parallel to the optical axis of the objective lens 9. Then, the focus evaluation values of the image signals successively acquired by the image capturing device and passing through the pretreatment portion 20 and the A/D conversion portion 21 are calculated.

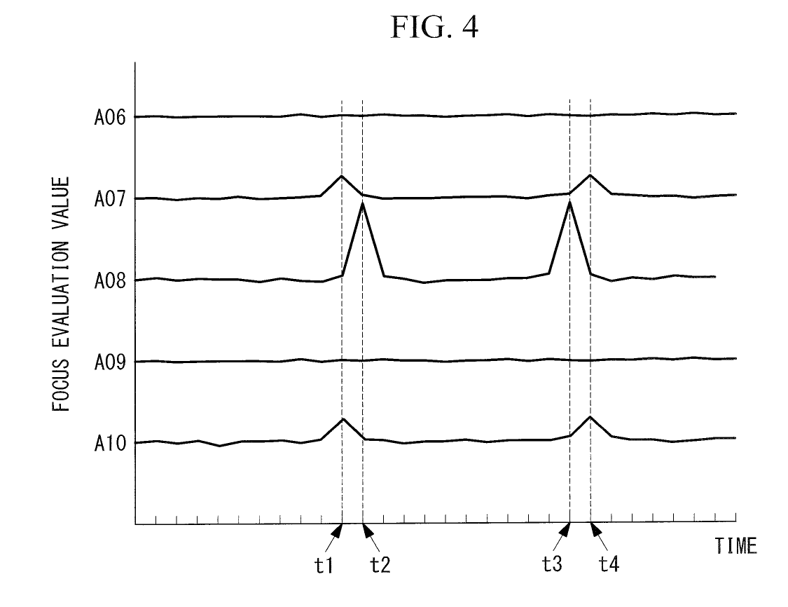

The calculated focus evaluation values are successively sent to the computer 4 via the control portion 28 and the I/F portion 27, and a chronological graph, as shown in FIG. 4, is formed in the computer 4 and is displayed on the monitor 31.

The operation of the thus-configured microscope system 1 according to this embodiment will be described below.

When performing fluorescence observation of the specimens A using the microscope system 1 according to this embodiment, an observer first inputs a focus adjustment instruction from the input portion 29 of the computer 4, with the specimens A being placed on the stage 5.

The focus adjustment instruction is sent from the computer 4 to the processing unit 3, in which the instruction is input to the control portion 28 via the I/F portion 27. The control portion 28 controls the microscope main unit 2 so as to successively output images of the specimens A and controls the image processing portion 26 so as to calculate the focus evaluation values.

More specifically, the control portion 28 moves the stage 5 to an initial position, where the specimens A are located near a focal position O of the objective lens 9, and controls the image capturing device so as to capture images with an exposure time of a fraction of a second and at a frame rate of several frames/second (for example, 10 frames/second). The acquired images are sent to the image processing portion 26, where the standard deviations, serving as the focus evaluation values, are calculated.

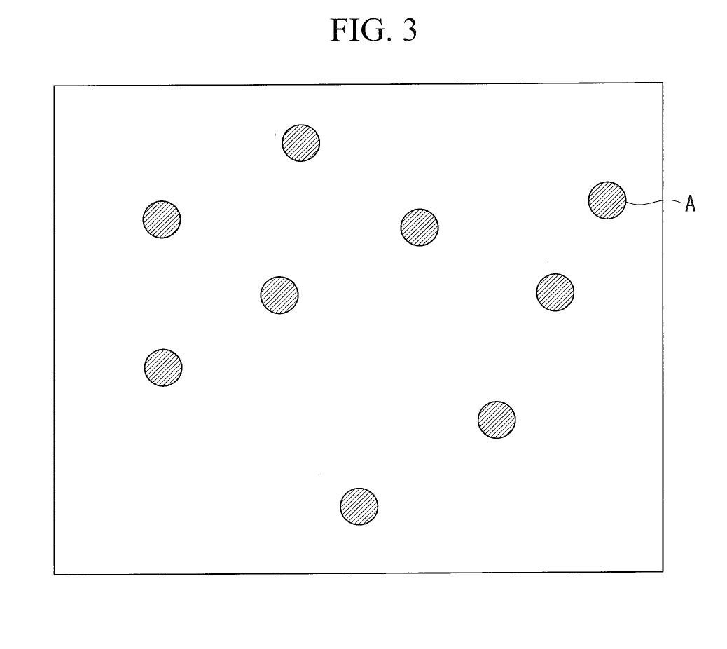

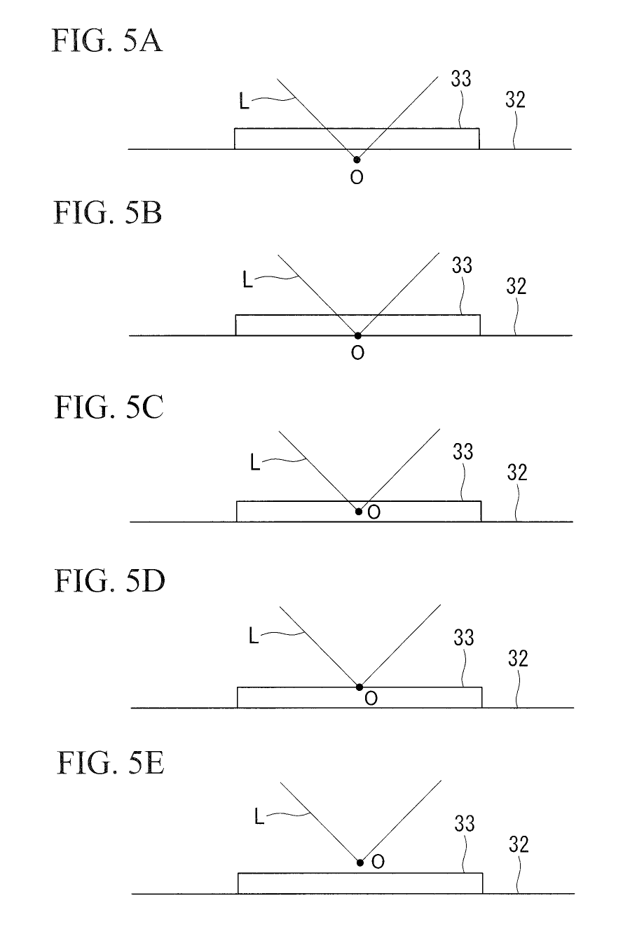

For example, when the specimens A as shown in FIG. 3 are placed on the stage 5, and a focus adjustment instruction is input, images are captured while the stage 5 is moved in the sequence FIG. 5A, FIG. 5B, FIG. 5C, FIG. 5D, FIG. 5E, FIG. 5D, FIG. 5C, FIG. 5B, and FIG. 5A, along the optical axis direction of the objective lens 9. By arranging the standard deviations calculated for the successively acquired respective images in chronological order, the graph in FIG. 4 is formed and displayed on the monitor 31. To simplify explanation, the graph in FIG. 4 shows only the standard deviations calculated with respect to the evaluation areas within a region R in FIG. 2.

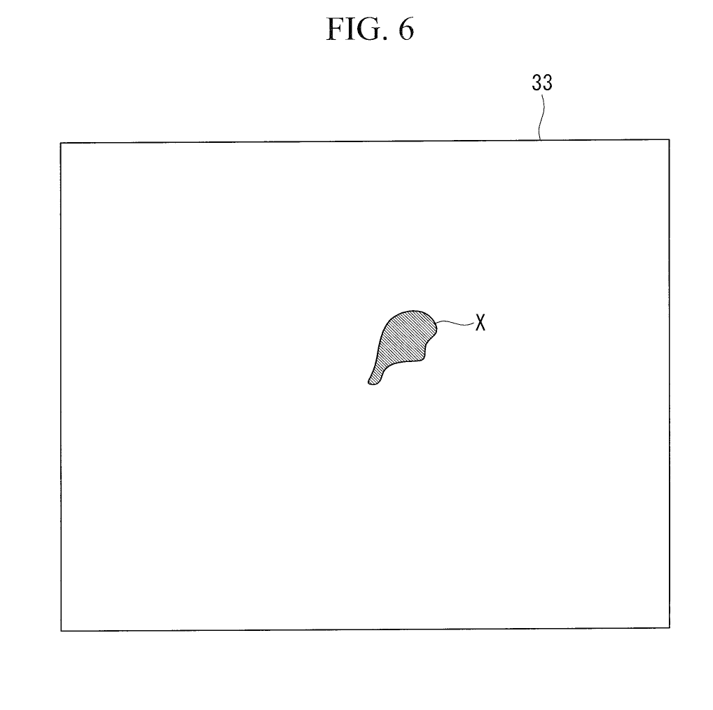

The specimens A shown as an example are disposed between a glass slide 32 and a cover glass 33, and dust X, as shown in FIG. 6, adheres to the cover glass 33.

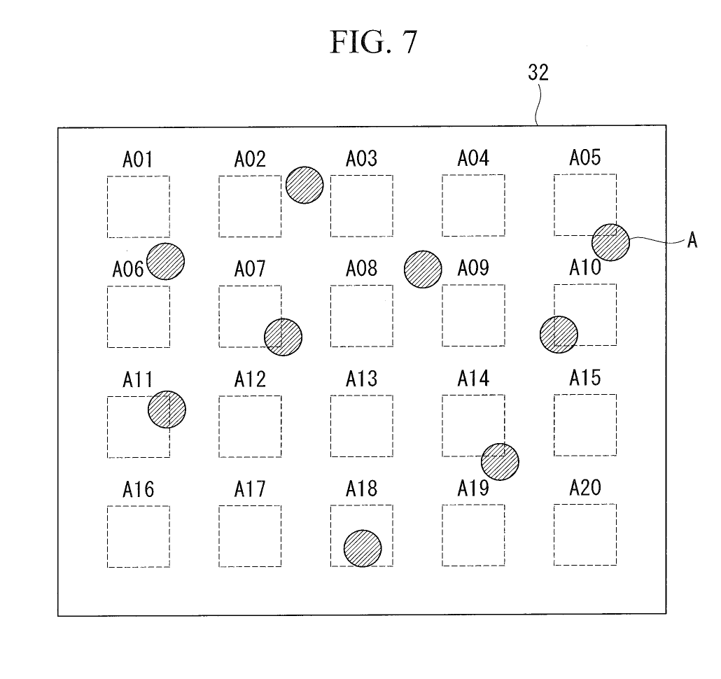

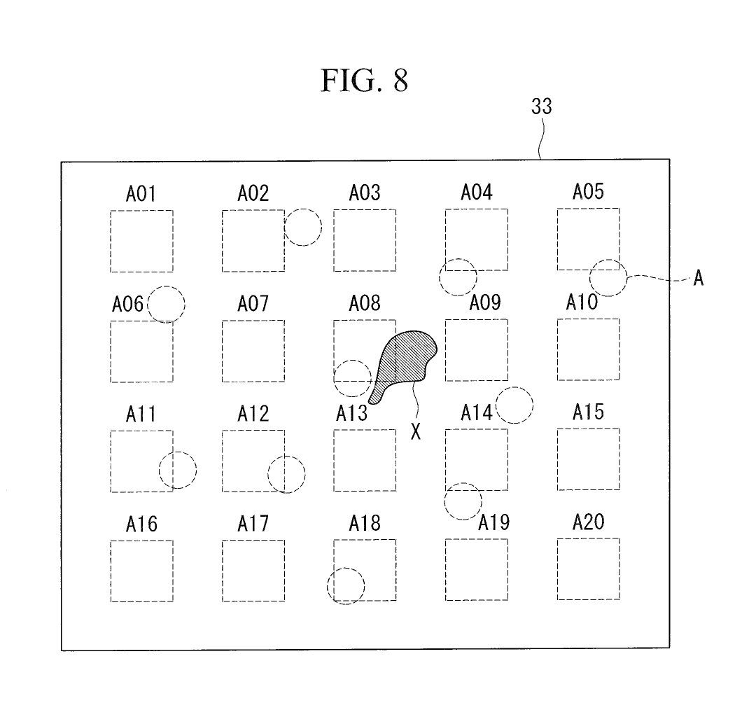

In the state in FIG. 5B, in which the specimens A are in focus, a fluorescence image of the specimens A as shown in FIG. 7 is acquired, whereas in the state in FIG. 5D, in which the top surface of the cover glass 33 is in focus, a fluorescence image as shown in FIG. 8, in which the dust X is brightly shining, is acquired.

As a result, as shown in FIG. 4, the standard deviations, serving as the focus evaluation values, in the evaluation areas A07 and A10 reach local maxima at the point of time t1, and the standard deviation in the evaluation area A08 reaches a local maximum at the point of time t2.

When more time has passed, the standard deviation in the evaluation area A08 reaches a local maximum at the point of time t3, and the standard deviations in the evaluation areas A07 and A10 reach local maxima at the point of time t4.

Because it is known that intense fluorescence is detected at the surfaces of the glass slide 32 and cover glass 33, on the basis of the direction in which the stage 5 moves and on the basis of the order in which the fluorescence is generated, it may be understood that the local maxima in the evaluation areas A07 and A10 are the standard deviations of the fluorescence image of the specimens A, and the local maximum in the evaluation area A08 is the standard deviation of the fluorescence image of the dust X.

Accordingly, by moving the stage 5 such that the local maxima appear in the evaluation areas A07 and A10, the observer can position the specimens A relative to the objective lens 9 in the manner shown in FIG. 5B and can perform focus adjustment such that a fluorescence image of the specimens A, in which all the specimens A are in focus, as shown in FIG. 7, can be acquired.

Then, by inputting a fluorescence observation instruction from the input portion 29 of the computer 4 after performing the focus adjustment in this manner, the exposure time is set to a few tens of seconds, and a clear fluorescence image can be acquired.

In this manner, with the microscope system 1 according to this embodiment, by displaying the focus evaluation values of the evaluation areas defined in an image area in chronological order, even when an image having a poor S/N ratio is used to calculate the focus evaluation values, a position where the image is in-focus can be easily recognized on the basis of the changes in the focus evaluation value with time. In particular, the use of the standard deviations in the small evaluation areas as the focus evaluation values provides the advantages that an output which is robust against noise and sensitive to a change in the image can be obtained, and that precise focus adjustment can be performed.

Although the standard deviation is used as the focus evaluation value in this embodiment, instead of this, a variance, an average value or a contrast value, a spatial frequency analysis result, or the like may be employed.

Furthermore, although the stage 5 is moved in the optical axis direction of the objective lens 9 under the control of the control portion 28 in this embodiment, instead of this, the stage 5 may be manually moved in the optical axis direction of the objective lens 9 based on an operation of the observer.

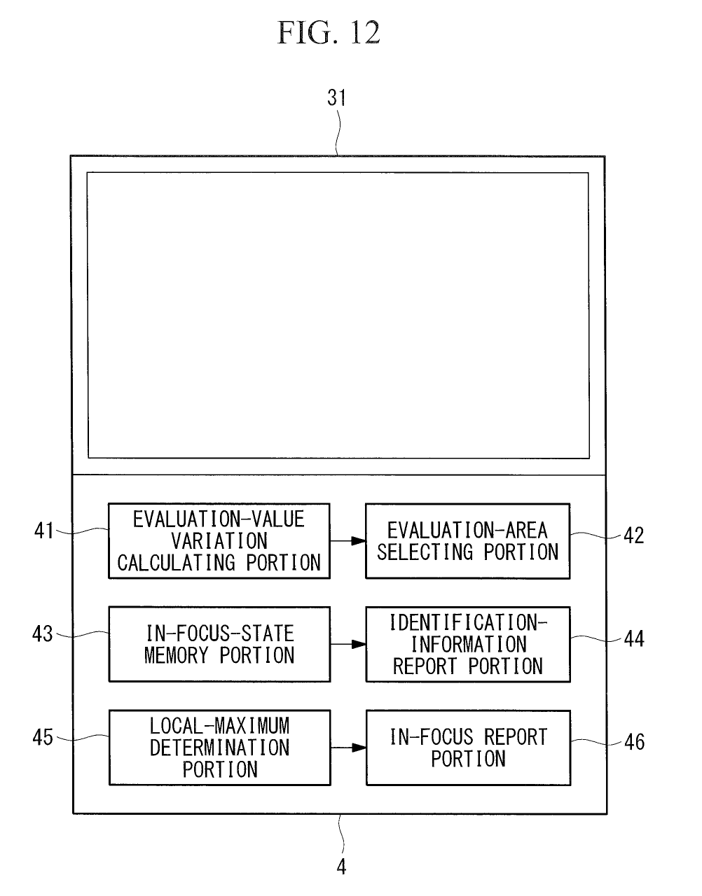

Furthermore, although the focus evaluation values calculated with respect to the specific evaluation areas are displayed chronologically in this embodiment, instead of this, focus evaluation values with a large variation may be selected and displayed. In such a case, as shown in FIG. 12, the computer 4 may include an evaluation-value variation calculating portion 41 that calculates the amount of change (variation), within a predetermined period of time, in the focus evaluation values calculated by the image processing portion 26 with respect to all the evaluation areas and sets a predetermined threshold on the basis of the amount of change, and an evaluation-area selecting portion 42 that selects, from all the evaluation areas, an evaluation area in which the predetermined threshold set by the evaluation-value variation calculating portion 41 is exceeded.

By doing so, it is possible to set the predetermined threshold, which is used when the evaluation-area selecting portion 42 selects the evaluation area, to an appropriate value, on the basis of the amount of change, within a predetermined period of time, of the focus evaluation values of the respective evaluation areas calculated by the evaluation-value variation calculating portion 41.

The microscope system 1 may be configured such that, with respect to the focus evaluation values of all the evaluation areas output from the processing unit 3, for example, the computer 4 may calculate the amount of change and average value of the focus evaluation values at positions where the image is obviously out of focus and, using the sum of the average value and the amount of change as a threshold, it may display, in chronological order, the focus evaluation values of the evaluation area in which the focus evaluation value exceeding the threshold is calculated.

Specifically, the threshold ThN in the respective evaluation areas A01 to A20 is:

ThN=MAX(FNt)−MIN(FNt)+AVERAGE(FNt) (1)

where FNt is the focus evaluation value at time t.

Assuming that time t is the time by which the frame rate is changed in stepwise manner and that the frame rate is 10 frames/second, a threshold evaluation time is 10 seconds, t=0, 0.1, . . . , 10 seconds.

Using these times, an evaluation area where FNt>ThN is extracted.

By doing so, it is possible to perform focus adjustment only for an area where a target part exists, while causing the focus evaluation value of an area where the focus evaluation value does not change over a range in which the focal position is changed, i.e., an area where the target part does not exist, not to be displayed on the monitor 31. In this way, the observer can easily specify the target part and can easily perform focus adjustment.

Furthermore, in this embodiment, it may be configured such that, when the focus evaluation value has a local maximum that is larger than the predetermined threshold, the pattern of the change is identified, and, when the focus evaluation value changes in the same pattern in the process of focus adjustment, the observer is reported to that effect.

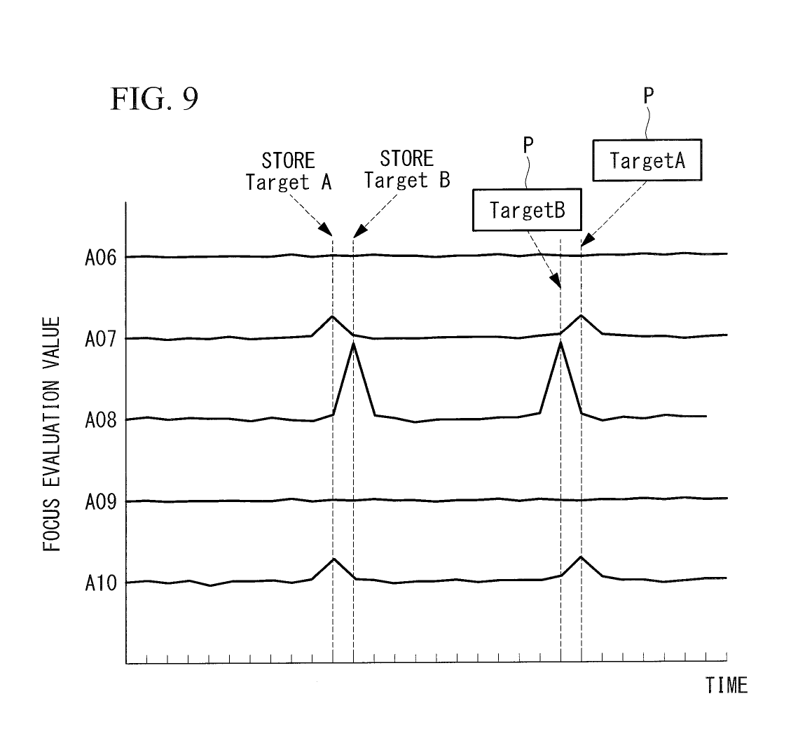

For example, in the in-focus state in FIG. 5B, the evaluation areas A05, A07, A10, A11, A14, and A18 are extracted, as shown in FIG. 7, and in the in-focus state in FIG. 5D, only the evaluation area A08 is extracted, as shown in FIG. 8. Hence, as shown in FIG. 12, the computer 4 may include an in-focus-state memory portion 43 that stores the combination of extracted evaluation areas or focus evaluation values with identification information, such as “Target A” and “Target B”, when an in-focus state is detected for the first time; and an identification-information report portion 44 that displays the identification information “Target A” and “Target B” on the chronological graph, in a superposed manner, when the local maximum is extracted in the same combination of the areas for the second time, as indicated by reference sign P in FIG. 9.

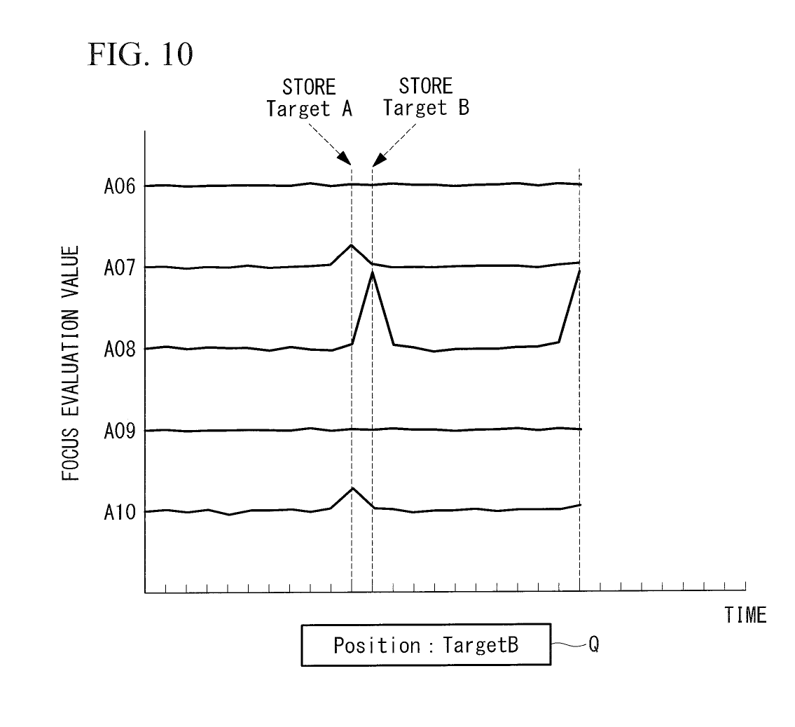

Alternatively, separately from the chronological graph, in the state where the focus evaluation value reaches the local maximum, a report may be issued using another arbitrary report means, such as sound, light, text, vibration, or the like. FIG. 10 shows an example in which the identification information “Position: Target B”, indicated by reference sign Q, is reported by a text indication, separately from the chronological graph.

By doing so, it is possible to obtain an advantage that the observer can more easily recognize a change in focus evaluation value and can easily perform focus adjustment.

Furthermore, with the focus evaluation value that uses the standard deviation, it may be difficult to determine the local maximum by using the threshold. In such a case, as shown in FIG. 12, the computer 4 may include a local-maximum determination portion 45 that, every time a focus evaluation value is calculated, obtains the difference with respect to the focus evaluation value calculated immediately before and detects that the focus evaluation value reaches a local maximum at a position where the sign of the difference value is inverted from plus to minus; and an in-focus report portion 46 that, when the local-maximum determination portion 45 has detected the local maximum, issues a report to that effect.

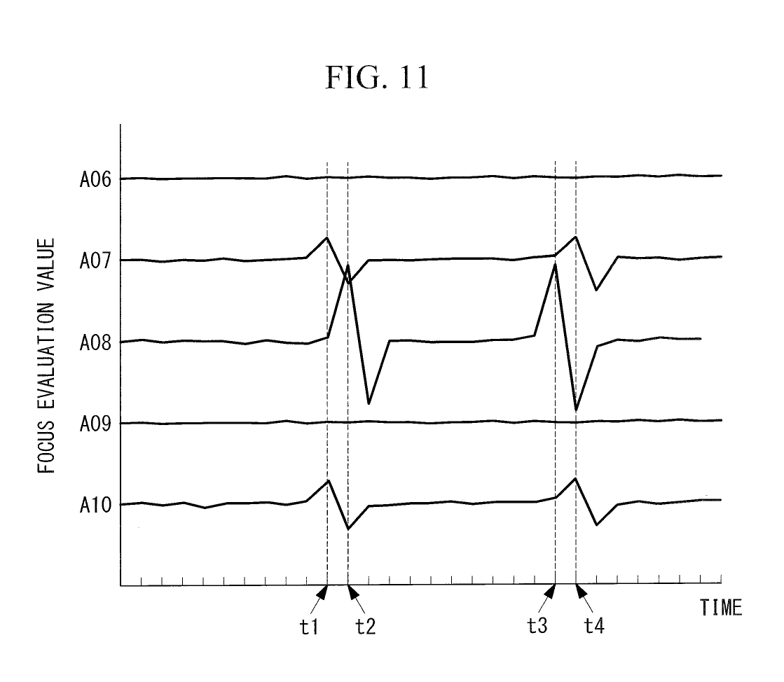

For example, FIG. 11 shows the result of calculation of the difference values of the focus evaluation values shown in FIG. 4 of the above embodiment. In this way, the local-maximum determination portion 45 can easily detect the points where the focus evaluation values reach local maxima, and it is possible to clearly show that the in-focus state is achieved with the in-focus report portion 46.

Note that the in-focus report portion 46 may determine whether or not the in-focus state is achieved, according to whether or not the focus evaluation value at the point where it reaches a local maximum satisfies the above-described (1); or it may calculate thresholds ThPΔN and ThMΔN from Expressions (2) and (3) below, using a difference value ΔFNt of the focus evaluation value at time t,

ThPΔN=AVERAGE(ΔFNt)+MAX(ΔFNt)−MIN(ΔFNt) (2)

ThMΔN=AVERAGE(ΔFNt)−MAX(ΔFNt)+MIN(ΔFNt) (3)

and report that the in-focus state is achieved, provided that the following conditional expression is satisfied:

ΔFNt>ThPΔN, ΔFNt+STEP<ThMΔN.

Herein, ΔFNt+STEP shows the difference value of the focus evaluation value at a point next to the point where the focus evaluation value is determined to be at the local maximum.

Furthermore, in a modification of this embodiment, a computer program for achieving the functions of the evaluation-value variation calculating portion 41, the evaluation-area selecting portion 42, the in-focus-state memory portion 43, the identification-information report portion 44, the local-maximum determination portion 45, and the in-focus report portion 46 is installed in the computer 4.

Furthermore, a general-purpose processing unit operated by a computer program, such as general-purpose computer, a personal computer, or the like, may be used as hardware constituting the image processing portion 26. Thus, the image processing portion 26 may be built into the computer 4.

The above-described embodiment is derived from the individual aspects of the present invention below.

An aspect of the present invention is a microscope system including a microscope main unit that acquires an image of a specimen; an evaluation-value calculating portion that calculates a focus evaluation value of an evaluation area defined in the acquired image, while moving the focal position with the microscope main unit; and a display portion that displays the focus evaluation value calculated by the evaluation-value calculating portion in chronological order.

According to this aspect, when focus adjustment relative to the specimen is started in the microscope main unit, the microscope main unit acquires an image of the specimen while moving the focal position, and the evaluation-value calculating portion calculates the focus evaluation value of the evaluation area defined in the image. Then, the calculated focus evaluation value is displayed on the display portion chronologically, whereby the observer can visually recognize changes in the focus evaluation value with time and can easily find the focal position where the focus evaluation value reaches a local maximum.

In this case, even if the exposure time for acquiring the image that is used to calculate the focus evaluation value is made sufficiently shorter than the exposure time for acquiring an image needed to observe the specimen, by displaying changes in the focus evaluation value of the evaluation area with time, it is possible to make the focal position where the focus evaluation value reaches a local maximum apparent. Therefore, when weak light is observed, even if an image having a poor S/N ratio, which is acquired without waiting for the exposure time to acquire an image needed for observation of the specimen, is used, precise focus adjustment can be performed with a sufficiently short time.

In the above-described aspect, the evaluation-value calculating portion may calculate the focus evaluation values of a plurality of evaluation areas defined in the acquired image.

By doing so, it is possible to visually recognize changes in the focus evaluation values with time at a plurality of positions in the image, while moving the focal position with the microscope main unit. Therefore, even when the position of the target part cannot be specified in an image in which weak light is captured, by displaying changes in the focus evaluation values with time, it is possible to distinguish between states in which a specimen surface is in focus and in which an object surface other than the specimen surface is in focus.

In the above-described aspect, an evaluation-area selecting portion that selects an evaluation area in which the focus evaluation value exceeds a predetermined threshold from the plurality of evaluation areas may be provided, and the display portion may display the focus evaluation value of the evaluation area selected by the evaluation-area selecting portion.

By doing so, only the evaluation area in which the focus evaluation value exceeds the predetermined threshold is selected by the evaluation-area selecting portion. Then, due to the focus evaluation value of the selected evaluation area being displayed on the display portion in chronological order, it is possible to visually recognize changes in the focus evaluation value with time in the evaluation area where the presence of the target part is likely. Specifically, by eliminating, from the display object, the focus evaluation value of the evaluation area where the presence of the target part is unlikely, the task of focus adjustment can be made easy.

In the above-described aspect, an evaluation-value variation calculating portion may be provided, which calculates a variation, within a predetermined period of time, of the focus evaluation values of the plurality of evaluation areas calculated by the evaluation-value calculating portion and sets the predetermined threshold according to the variation.

By doing so, it is possible to set the predetermined threshold, which is used when the evaluation-area selecting portion selects the evaluation area, to an appropriate value, on the basis of the variation, within a predetermined period of time, of the focus evaluation values of the respective evaluation areas calculated by the evaluation-value variation calculating portion.

In the above-described aspect, a local-maximum determination portion that determines whether the focus evaluation value detected by the evaluation-value calculating portion is at a local maximum; and an in-focus report portion that reports that an in-focus state is achieved when the focus evaluation value that is determined to be at the local maximum by the local-maximum determination portion exceeds the predetermined threshold may be provided.

By doing so, when the focus evaluation value is determined to be at the local maximum by the local-maximum determination portion and is larger than the predetermined threshold, the in-focus report portion reports that the in-focus state is achieved, whereby the observer can more easily recognize the in-focus state.

In the above-described aspect, the microscope main unit may move the focal position several times within a predetermined range, and the microscope system may include an in-focus-state memory portion that stores an in-focus state reported by the in-focus report portion, together with identification information; and an identification-information report portion that reports the identification information stored in the in-focus-state memory portion when the in-focus state stored in the in-focus-state memory portion is reported again by the in-focus report portion.

By doing so, when an in-focus state is reported in the first focal position movement, the in-focus state is stored in the in-focus-state memory portion together with the identification information, and when the same in-focus state is reported when passing through the same focal position again, the identification information is reported by the identification-information report portion. For example, when the microscope main unit moves the focal position along forward and return paths relative to the specimen, if the in-focus state is reported twice in the forward path, the in-focus states at the respective report occasions are stored in the in-focus-state memory portion, together with identification information “Target A” and identification information “Target B”, then the identification information “Target B” and the identification information “Target A” are reported in sequence at the respective in-focus positions in the return path. Thus, the observer can more easily recognize the in-focus state.

### REFERENCE SIGNS LIST

1 microscope system
2 microscope main unit
25 focus-evaluation-value calculating portion (evaluation-value calculating portion)
31 monitor (display portion)
A specimen

1. A microscope system comprising:
a microscope main unit that acquires an image of a specimen;
an evaluation-value calculating portion that calculates a focus evaluation value of an evaluation area defined in a field-of-view range, while moving a focal position with the microscope main unit; and
a display portion that displays the focus evaluation value calculated by the evaluation-value calculating portion in chronological order.

2. The microscope system according to claim 1,
wherein the evaluation-value calculating portion calculates the focus evaluation values of a plurality of evaluation areas defined in the field-of-view range.

3. The microscope system according to claim 2, further comprising an evaluation-area selecting portion that selects an evaluation area in which the focus evaluation value exceeds a predetermined threshold from the plurality of evaluation areas,
wherein the display portion displays the focus evaluation value of the evaluation area selected by the evaluation-area selecting portion.

4. The microscope system according to claim 3, further comprising an evaluation-value variation calculating portion that calculates a variation, within a predetermined period of time, of the focus evaluation values of the plurality of evaluation areas calculated by the evaluation-value calculating portion and sets the predetermined threshold according to the variation.

5. The microscope system according to claim 1, further comprising:
a local-maximum determination portion that determines whether the focus evaluation value detected by the evaluation-value calculating portion is at a local maximum; and
an in-focus report portion that reports that an in-focus state is achieved when the focus evaluation value that is determined to be at the local maximum by the local-maximum determination portion exceeds the predetermined threshold.

6. The microscope system according to claim 5, wherein
the microscope main unit moves the focal position several times within a predetermined range, and
the microscope system includes:
an in-focus-state memory portion that stores an in-focus state reported by the in-focus report portion, together with identification information; and
an identification-information report portion that reports the identification information stored in the in-focus-state memory portion when the in-focus state stored in the in-focus-state memory portion is reported again by the in-focus report portion.
